(19) United States
(12) Patent Application Publication
(10) Pub. No.: US 2018/0374082 A1
(43) Pub. Date: Dec. 27, 2018

(54) FUND TRANSFER ORCHESTRATION SWITCH AND METHOD

(71) Applicant: Mastercard International Incororated, Purchase, NY (US)

(72) Inventors: Sadipan Bhattacharjee, Vadodara (IN); Kumardip Chakraborty, Kolkata (IN); Jinen Patel, Nadiad (IN)

(73) Assignee: Mastercard International Incorporated, Purchase, NY (US)

(21) Appl. No.: 16/015,804

(22) Filed: Jun. 22, 2018

(30) Foreign Application Priority Data
Jun. 23, 2017 (IN) 201711022087

(51) Int. Cl. G06Q 20/36; G06Q 20/22

(52) U.S. Cl. CPC G06Q 20/36; G06Q 20/223

(57) ABSTRACT

There is provided a money transfer orchestration switch and money transfer method. The switch includes an instruction receiving component for receiving transfer instructions to transfer money from a source digital wallet to a target digital wallet. The switch includes use of an intermediary account for receiving money from the source digital wallet before depositing the money into the target digital wallet. The switch further includes a money transmitting component for transmitting the money from the intermediary account to the target digital wallet.

### CROSS-REFERENCE TO RELATED APPLICATIONS

This application claims priority to Indian Application Serial No. 201711022087, filed Jun. 23, 2017, which is incorporated herein by reference in its entirety

### TECHNICAL FIELD

The present invention broadly relates to the management of digital wallets storing value in the form of money, and more particular, to the control of money stored in digital wallets.

### BACKGROUND

Traditionally, financial transactions, and in particular transactions involving the purchase of goods for relatively low sums of money, have taken place using cash. For the large proportion of the world which does not have a bank account, cash is one of the few mechanisms available for financial transactions. Accordingly, cash remains an important mode of currency for both banked and unbanked societies.

The advent of digital wallets has seen a decline in the use of physical currency to represent cash. Digital wallets store an electronic representation of value which can be used like cash. Instead of storing bank notes in their physical wallet, users can store a corresponding value in their digital wallet. Unlike other conventional non-cash payment mechanisms, payment is not made from a bank account controlled by a financial institution—the value is stored in the wallet itself. This has the advantage that payments may be made without the involvement of a bank account, which is particularly useful if the user does not have a bank account, or is in an area where a bank account is inaccessible. Furthermore, electronic transactions using such stored-value digital wallets are often quicker than those that involve electronic communication with a bank for authorisation, as such communication (and its associated delays) are rendered unnecessary.

Digital wallets are provided to users by digital wallet providers. Those providers not only provide the digital wallets, but also typically provide a mechanism for getting funds into and out of the digital wallets. Where a digital wallet is associated with a bank account, funds are transferred from the bank account to the digital wallet (and sometimes from the digital wallet to the bank account) using tools provided by the digital wallet provider. As control of the funds in the digital wallet is constrained by the tools provided by the digital wallet provider, flexible access to the funds is limited.

It is desired to address one or more shortcomings or disadvantages of the prior art, or at least provide a useful alternative.

### SUMMARY

In one embodiment, the present invention provides a money transfer orchestration switch. The switch includes an instruction receiving component for receiving transfer instructions to transfer money from a source digital wallet to a target digital wallet. The switch further includes a money receiving component for receiving money from the source digital wallet into an intermediary account. The switch further includes a money transmitting component for transmitting the money from the intermediary account to the target digital wallet.

In a further embodiment, the present invention provides a method for transferring money from a source digital wallet to a target digital wallet. The method includes, at a switch
a. receiving the money from the source digital wallet into an intermediary account; and
b. transmitting the money from the intermediary account to the target digital wallet.

### BRIEF DESCRIPTION OF THE DRAWINGS

Preferred embodiments of the present invention are hereinafter described, by way of example only, with reference to the accompanying drawings, in which:

FIG. 1 is an architecture diagram illustrating a digital wallet associated with a bank account at a financial institution.

FIG. 2 is an architecture diagram illustrating a device having two digital wallets in communication with a money transfer orchestration switch.

FIG. 3 is an illustration of an exemplary user interface for transferring money between digital wallets.

FIG. 4 is a flow chart of an exemplary process executed by a money transfer orchestration switch to transfer money between digital wallets.

FIG. 5 is a schematic diagram showing components of an example server shown in FIG. 2.

FIG. 6 is a schematic diagram showing components of an example smartphone as shown in FIG. 1.

### DETAILED DESCRIPTION

There is provided a money transfer orchestration switch and money transfer method. The switch includes an instruction receiving component for receiving transfer instructions to transfer money from a source digital wallet to a target digital wallet. The switch includes use of an intermediary account for receiving money from the source digital wallet before depositing the money into the target digital wallet. The switch further includes a money transmitting component for transmitting the money from the intermediary account to the target digital wallet.

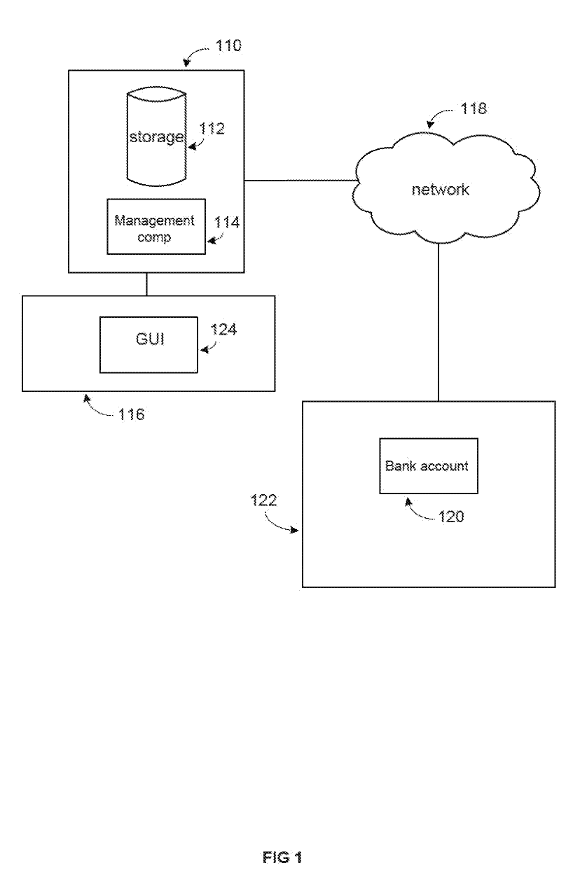

As illustrated in FIG. 1, a digital wallet 110 may consist of a storage component 112 which is often cryptographically secured and contains the value of the funds in the wallet, and a management component 114, coupled to the storage component 112, which is responsible for providing and regulating access to the funds stored in the storage component 112. The storage component 112 and management component 114 are necessarily coupled together, and may (but not necessarily) be part of the same device. For example, the storage component can be in a cloud. The exemplary digital wallet 110 illustrated in FIG. 1 is part of a smartphone 116, the management component 114 exposing a graphical user interface 124 as part of an application installed on the smartphone 116. The digital wallet 110 may alternatively be part of any other portable or non-portable computing device.

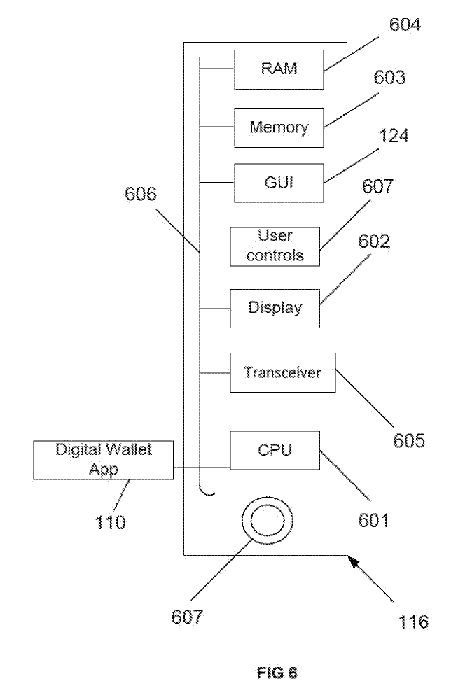

The smartphone 116 of any of the examples herein may be a handheld computer device such as one manufactured by Apple™, LG™, Huawei™, Sony™, Samsung™ or Motorola™. A mobile computer such as a tablet computer or wearable device like a smartwatch can also replace the smartphone 116. An exemplary embodiment of the smartphone 116 is shown in FIG. 6. As shown, the smartphone 116 includes the following components in electronic communication via a bus 606:
1. a display 602;
2. non-volatile memory 603;
3. random access memory (“RAM”) 604;
4. N processing components 601;
5. a transceiver component 605 that includes N transceivers;
6. a graphical user interface 124; and
7. user controls 607.

Although the components depicted in FIG. 6 represent physical components, FIG. 6 is not intended to be a hardware diagram; thus many of the components depicted in FIG. 6 may be realized by common constructs or distributed among additional physical components. Moreover, it is certainly contemplated that other existing and yet-to-be developed physical components and architectures may be utilized to implement the functional components described with reference to FIG. 6.

The display 602 generally operates to provide a presentation of content to a user, and may be realized by any of a variety of displays (e.g., CRT, LCD, HDMI, micro-projector and OLED displays). And in general, the non-volatile memory 603 functions to store (e.g., persistently store) data and executable code including code that is associated with the functional components of a browser component and applications, and in one example, the payment application (digital wallet application) 110. In some embodiments, for example, the non-volatile memory 603 includes bootloader code, modem software, operating system code, file system code, and code to facilitate the implementation of one or more portions of the payment application 110 as well as other components well known to those of ordinary skill in the art that are not depicted for simplicity.

In many implementations, the non-volatile memory 603 is realized by flash memory (e.g., NAND or ONENAND memory), but it is certainly contemplated that other memory types may be utilized as well. Although it may be possible to execute the code from the non-volatile memory 603, the executable code in the non-volatile memory 603 is typically loaded into RAM 604 and executed by one or more of the N processing components 601.

The N processing components 601 in connection with RAM 604 generally operate to execute the instructions stored in non-volatile memory 603 to effectuate the functional components. As one of ordinarily skill in the art will appreciate, the N processing components 601 may include a video processor, modem processor, DSP, graphics processing unit (GPU), and other processing components.

The transceiver component 605 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The management component 114 may access resources and communicate over a computer network 118. Where the storage component 112 and the management component 114 are not part of the same device, the management component 114 may use the computer network 118 to communicate with the storage component 112 (in an architecture not illustrated in FIG. 1). Alternatively or additionally, the management component 114 may use the computer network 118 to communicate with external devices and organisations, such as a financial institution server 122.

The computer network 118 may take any suitable form, including a wireless or wired local, metropolitan or wide area network. Where the digital wallet 110 is part of a smartphone 116, the computer network 118 may include a mobile telecommunications network, or a wireless local area network.

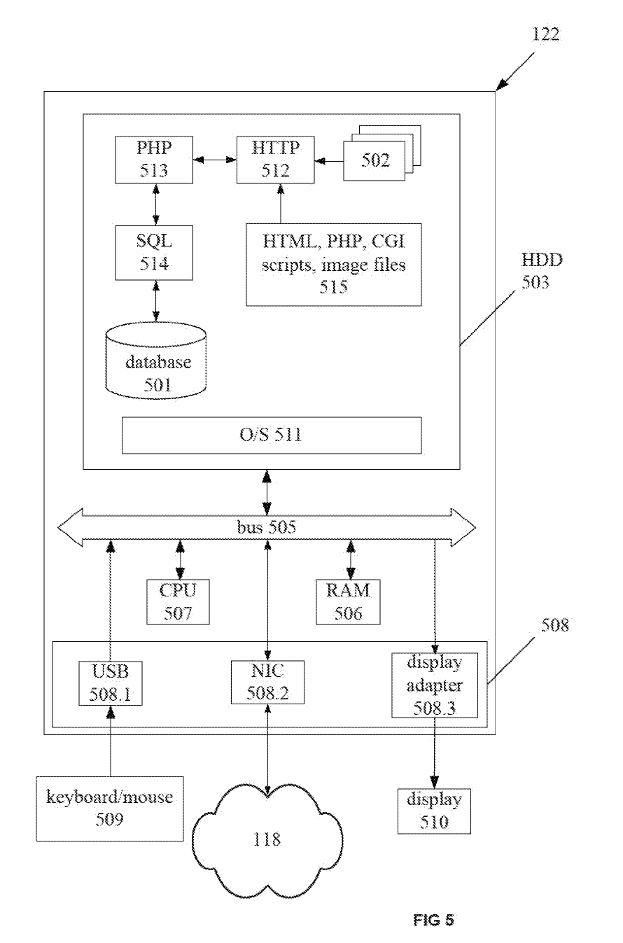

The financial institution server 122 of any of the examples herein may be formed of any suitable processing device, and one such suitable device is shown in FIG. 5.

In this example, a processing device is provided by a server 122 in communication with a database 501, as shown in FIG. 5. The server 122 is able to communicate with other processing devices, as required, over the computer network 118 using standard communication protocols.

The components of the server 122 can be configured in a variety of ways. The components can be implemented entirely by software to be executed on standard computer server hardware, which may comprise one hardware unit or different computer hardware units distributed over various locations, some of which may require the computer network 118 for communication. A number of the components or parts thereof may also be implemented by application specific integrated circuits (ASICs) or field programmable gate arrays.

In the example shown in FIG. 5, the server 122 is a commercially available server computer system based on a 32 bit or a 54 bit Intel architecture, and the processes and/or methods executed or performed by the server 122 are implemented in the form of programming instructions of one or more software components or modules 502 stored on non-volatile (e.g., hard disk) computer-readable storage 503 associated with the server 122. At least parts of the software modules 502 could alternatively be implemented as one or more dedicated hardware components, such as application-specific integrated circuits (ASICs) and/or field programmable gate arrays (FPGAs).

The server 122 includes at least one or more of the following standard, commercially available, computer components, all interconnected by a bus 505:
1. random access memory (RAM) 506;
2. at least one computer processor 507, and
3. external computer interfaces 508:
a. universal serial bus (USB) interfaces 508.1 (at least one of which is connected to one or more user-interface devices, such as a keyboard, a pointing device (e.g., a mouse 509 or touchpad),
b. a network interface connector (NIC) 808.2 which connects the server 122 to a data communications network, such as the Internet 550; and
c. a display adapter 508.3, which is connected to a display device 510 such as a liquid-crystal display (LCD) panel device.

The server 122 includes a plurality of standard software modules, including:
1. an operating system (OS) 511 (e.g., Linux or Microsoft Windows);
2. web server software 512 (e.g., Apache, available at http://www.apache.org);
3. scripting language modules 513 (e.g., personal home page or PHP, available at http://www.php.net, or Microsoft ASP); and
4. structured query language (SQL) modules 514 (e.g., MySQL, available from http://www.mysql.com), which allow data to be stored in and retrieved/accessed from an SQL database.

Together, the web server 512, scripting language 513, and SQL modules 514 provide the server 122 with the general ability to allow users of the computer network 118 with standard computing devices equipped with standard web browser software to access the server 122 and in particular to provide data to and receive data from the database 501. It will be understood by those skilled in the art that the specific functionality provided by the server 122 to such users is provided by scripts accessible by the web server 512, including the one or more software modules 502 implementing the processes performed by the server 122, and also any other scripts and supporting data 515, including markup language (e.g., HTML, XML) scripts, PHP (or ASP), and/or CGI scripts, image files, style sheets, and the like.

The boundaries between the modules and components in the software modules 502 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the server 122 may be executed by a module (of software modules 502) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 122 normally processes information according to a program (a list of internally stored instructions such as a particular application program and/or an operating system) and produces resultant output information via input/output (I/O) devices 508. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Where the digital wallet 110 is associated with a bank account 120, the management component 114 may communicate over the computer network 118 with the computing systems of the financial institution server 122 controlling the associated bank account 120, to ensure that funds can be transferred to the digital wallet 110 from the associated bank account 120, (and in some exemplary digital wallet implementations, transferred from the digital wallet 110 to the associated bank account 120).

As indicated above, the management component 114 of the digital wallet 110 may expose a user interface 124, enabling a user to manipulate the funds within the storage component 112. Such a user interface 124 may be part of a digital wallet management application. Some exemplary functions that may be exposed by the user interface 124 include:
Making payments to merchants from funds in the storage component 112;
Retrieving and viewing the balance of the funds in the storage component 112;
Reviewing a transaction history recording transactions made using funds in the storage component 112.
“Recharging” or “refilling” the digital wallet by coordinating the transfer of funds from an associated bank account 120 to the storage component 112.

This last function requires the management component 114 to communicate over the computer network 118 with the financial institution server 122.

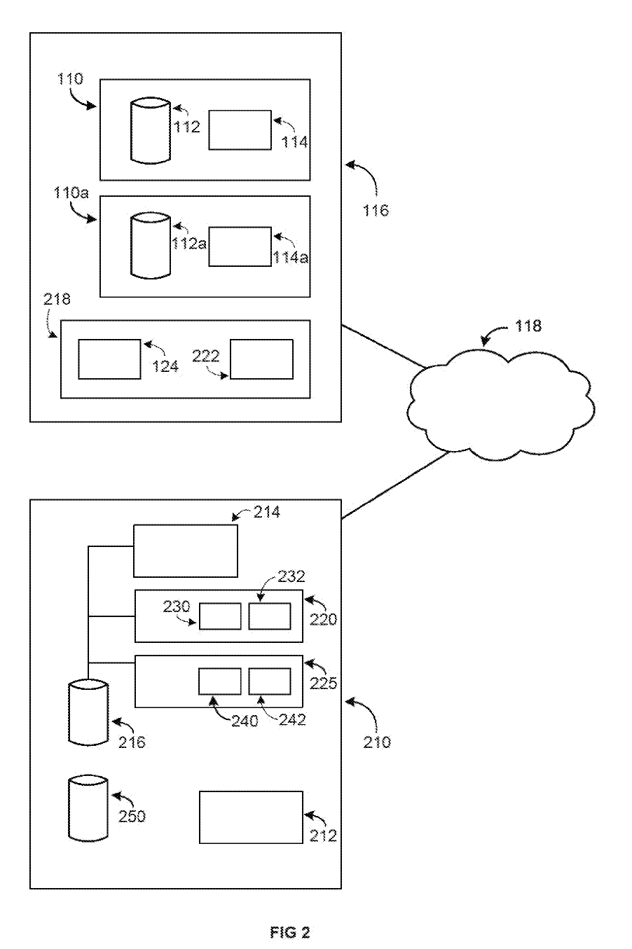

As illustrated in FIG. 2, the management component 114 may also communicate using the computer network 118 with an intermediary account manager 210 which controls funds stored in an intermediary account 212. Although the intermediary account manager 210 and intermediary account 212 are shown as being connected to management component 114 using the computer network 118, in other embodiments the intermediary account manager 210 and intermediary account 212 may be stored on the same device which stores the digital wallet 110.

In the exemplary embodiment illustrated in FIG. 2, the device which stores the digital wallet 110 may store a second digital wallet 110a, which in turn includes a management component 114a and a storage component 112a. The funds stored in storage component 112a are typically separate from those stored in storage component 112. Digital wallet 110a may be provided by a different wallet provider to that which provided digital wallet 110, and in any event such wallets are typically completely independent of each other.

There may be circumstances where it is desirable to transfer funds between storage components of different digital wallets. For example, a merchant may only accept payment from digital wallet 110a. A user may have insufficient funds in digital wallet 110a, but may have ample funds in digital wallet 110. However, the merchant's point of sale equipment or other infrastructure may not be able to communicate with digital wallet 110. Should the user be able to transfer funds from digital wallet 110 to digital wallet 110a, this would enable the purchase to be made.

To facilitate such wallet-to-wallet transfers, such as the transfer of funds from wallet 110 (the source digital wallet) to wallet 110a (the target digital wallet), the source digital wallet 110 and target digital wallet 110a both communicate with intermediary account manager 210. In some embodiments, this communication occurs through respective management components 114 and 114a. Intermediary account manager 210 operates as a money transfer orchestration switch, and includes an instruction receiving component 214 for receiving transfer instructions to transfer money from a source digital wallet 110 to a target digital wallet 110a.

The money transfer orchestration switch 210 may have access to an account database 216 which stores details of digital wallets or digital wallet providers, to facilitate communication with different wallets, including the source digital wallet 110 and the target digital wallet 110a. For example, the account database 216 may store details regarding wallet provider A, such as the format and type of messages that can be sent to the management component of a wallet provided by provider A. Alternatively or additionally, it may store unique details identifying individual digital wallets, to enable communication with those wallets. The unique details can include identifiers for the individual digital wallets. It should be noted that the individual digital wallets can be from a single digital wallet provider or from a plurality of digital wallet providers.

The instruction receiving component 214 may communicate with an application 218 running on a device which is also communicatively coupled with the source digital wallet 110 and the target digital wallet 110a. Application 218 may include a user interface component 124 for receiving user interface events representing instructions from a user. The application 218 may also include an instruction transmitting component 222. The instruction transmitting component 222 may communicate directly with the wallet management components 114, 114a. Alternatively, it may simply rely on its communication with instruction receiving component 214 of intermediary account manager 210.

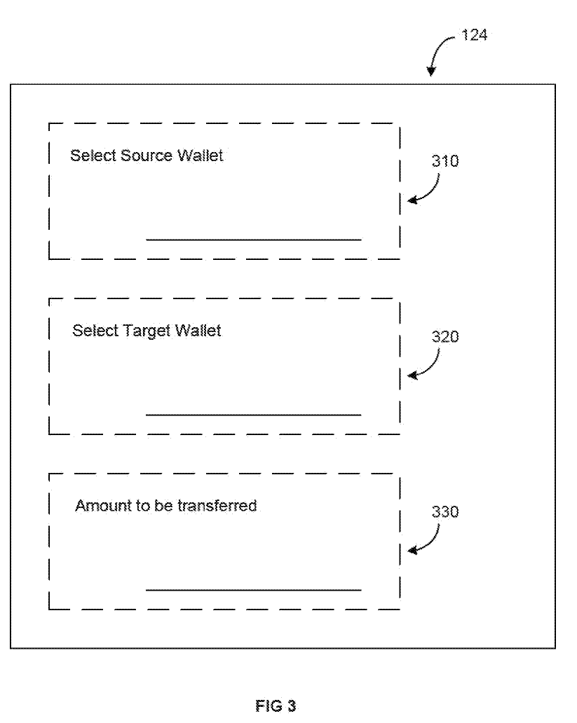

An exemplary user interface 124 of application 218 is illustrated in FIG. 3. The user interface 124 illustrated in FIG. 3 is one which is displayed on a display of a device having access to the source digital wallet 110 and target digital wallet 110a.

The user interface 124 includes a source wallet selection area 310 which includes controls enabling a user to select a source wallet from which funds are to be transferred. The user interface 124 also includes a target wallet selection area 320 which includes controls enabling a user to select a target wallet into which funds are to be transferred. The user interface 124 also includes an amount selection area 330 which contains controls enabling a user to select or enter an amount of funds to be transferred from the source wallet to the target wallet.

Application 218 may then commence transferring funds from the source wallet to the target wallet. This may occur by the instruction transmitting component of application 218 sending a signal or message directly to the management component of the source wallet (for example, management component 114 of wallet 110). This message or signal causes wallet management component 114 to initiate transfer of the funds from storage component 112 to intermediary account 212 controlled by intermediary account manager 210.

Alternatively, application 218 may commence transferring funds from source wallet 110 to target wallet 110a by instructing transmitting component 222 to send a signal or message to instruction receiving component 214 of intermediary account manager 210. The signal or message may identify the source wallet, target wallet and amount to be transferred. Intermediary account manager 210 may then communicate with wallet management component 114 of digital wallet 110 to initiate the transfer of funds from storage component 112 to intermediary account 212.

The transfer of funds from digital wallet 110 to intermediary account 212 may occur in the same manner in which funds are transferred between digital wallet 110 and associated bank account 120. The money transferred from source wallet 110 is received by a money receiving component 220 of money transfer orchestration switch 210. The money receiving component 220 receives money from the source digital wallet 110 and stores it in intermediary account 212. A money transmitting component 225 of orchestration switch 210 is then responsible for transmitting the received funds to target digital wallet 110a. Again, the mechanism used to transfer funds may be the same as that which is used to top up the value of target digital wallet 110a from its associated bank account.

As can be seen from the above description, the money transfer orchestration switch 210 includes an instruction receiving component 214 for receiving transfer instructions to transfer money from a source digital wallet 110 to a target digital wallet 110a. The orchestration switch 210 also includes a money receiving component 220 for receiving money from the source digital wallet 110 into an intermediary account 212. A money transmitting component 225 of the orchestration switch 210 transmits the money from the intermediary account 212 to the target digital wallet 110a. The transfer instructions are received from an instruction transmitting component 222 which may be operable on a computing device (such as smartphone 116). The source digital wallet 110 and target digital wallet 110a may be stored on the computing device (smartphone 116) or are at least accessible from the computing device 116 (possibly through computer network 118).

As described above, the money receiving component 220 receives money from the source digital wallet 110 and stores it in intermediary account 212. To undertake this transfer, unless application 218 has been in direct contact with management component 114 of source wallet 110, money receiving component 220 must communicate with the source digital wallet 110 to implement the transfer of funds from source digital wallet 110 to intermediary account 212. It does so by means of a source digital wallet communications component 230, which is responsible for communicating with the source digital wallet 110.

To initiate the transfer of funds from the source digital wallet 110 to the intermediary account 212, the source digital wallet communications component 230 is configured to send a message to the source digital wallet 110 to cause the source digital wallet 110 to use a receiving interface 232 of the money receiving component 220 to effect transmission of the money from the source digital wallet 110 to the intermediary account 212. The receiving interface 232 may be in the form of an Application Programming Interface (API).

To effect a subsequent transfer of funds from intermediary account 212 to target digital wallet 110a, the money transfer orchestration switch 210, and more particularly the money transmitting component 225 of the switch 210 includes a target digital wallet communications component 240 for communicating with the target digital wallet 110a. To enable the target digital wallet communications component 240 to effect transfer of funds to the target digital wallet 110a, the target digital wallet communications component 240 is configured to send a message to the target digital wallet 110a to cause the target digital wallet 110a to use a transmitting interface 242 of the money transmitting component 225. The transmitting interface 242 is used to effect transmission of the money from the intermediary account 212 to the target digital wallet 110a.

Although the source digital wallet communications component 230 may be separate and distinct from target digital wallet communications component 240, in some embodiments these components may comprise the same software and/or hardware, the money transfer orchestration switch using a common digital wallet communications component to communicate with both the source digital wallet 110 and the target digital wallet 110a. In such circumstances, the common digital wallet communications component constitutes both the source digital wallet communications component 230 and the target digital wallet component 240.

The precise nature and format of the messages sent from the source digital wallet communications component 230 and target digital wallet communications component 240 is dependent upon the message formats used by the source of digital wallet 110 and target digital wallet 110a respectively. As previously described, details of usable message formats may be stored in accounts database 216.

The money transfer orchestration switch 210, as described above, efficiently enables funds to be transferred from a source digital wallet 110 to a target digital wallet 110a by effecting a transfer from source digital wallet 110 to an intermediary account 120, and a subsequent transfer from the intermediary account 120 to the target digital wallet 110a. Although this process may be initiated by a user operating user interface 124 of application 218, that user should only be able to instigate such a transfer if they are authorised to do so. An exemplary method of ensuring that the user is sufficiently authorised is to prompt the user, using user interface 124, to enter their credentials for accessing the source digital wallet 110. Those credentials may take the form of one or more biometric identifiers, one or more pieces of secret information (such as a username and password) or any other form that can uniquely identify the user.

The credential information received through the user interface 124 is sent to the money transfer orchestration switch 210. In a preferred embodiment, the money transfer orchestration switch 210 stores the credentials in a credential storage manager. The credential storage manager may take the form of a database 250, stored local to or remote from the transfer orchestration switch 210 (illustrated in FIG. 2 as being local to the switch 210). In an alternative embodiment, the credentials are only stored temporarily until the funds transfer transaction is complete.

To undertake a transfer, the user may be prompted by the user interface 124 to authenticate himself or herself (even when the transfer is to another digital wallet associated with himself or herself). That authentication need not, but may, involve or include the supply of credentials for accessing the source digital wallet 110. If the authentication information supplied by the user in response to the user interface prompt is different from that used to access the source digital wallet 110, the application 218 can send to the instruction receiving component 214 of orchestration switch 210 information indicating the identity of the user and the fact that the user has been authenticated. This enables the orchestration switch 210 to query the credential storage manager 250 to retrieve the credentials for accessing the source digital wallet 110, and subsequently use those credentials to initiate a transfer of funds from source digital wallet 110 to target digital wallet 110a.

As described above, a switch may be used to transfer money from a source digital wallet to a target digital wallet. In doing so, the switch receives the money from the source digital wallet into an intermediary account, and subsequently transmits the money from the intermediary account to the target digital wallet.

The switch may transfer money on receipt of instructions to transfer the money from the source digital wallet to the target digital wallet. These instructions may be received from a device having access to both the source digital wallet and the target digital wallet. For example, as described above, a smartphone 116 may store both a source digital wallet 110 and a target digital wallet 110a. Alternatively, one or more of the source and target digital wallets may be stored on an external server accessible to the smartphone 116 using network 118. In both cases, the switch 210 receives instructions from the smartphone 116 to transfer the funds, before transferring the funds to and from the intermediary account 212.

As described above, the switch 210 may initiate the transfer by sending a message to the source digital wallet 110 to cause the source digital wallet 110 to access a receiving interface 232 (such as an API) of the switch 210 to effect transmission of the money from the source digital wallet 110 to the intermediary account 212. Furthermore, the switch may complete the transfer by sending a message to the target digital wallet 110a to cause the target digital wallet to access a transmitting interface 242 (such as an API) of the switch 210 to effect transmission of the money from the intermediary account 212 to the target digital wallet 110a.

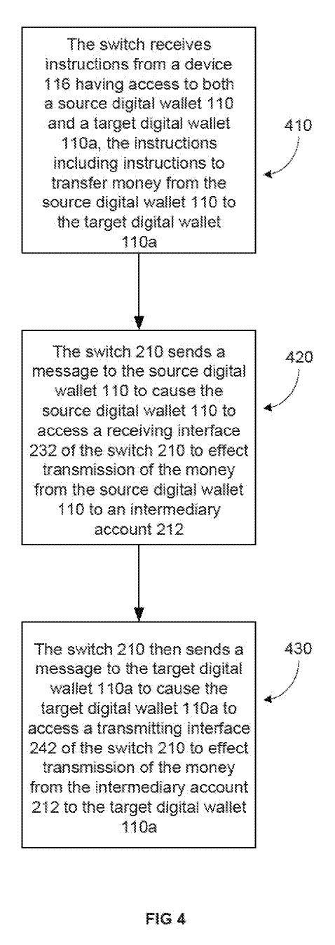

An exemplary process undertaken by switch 210 will now be described with reference to FIG. 4.

At step 410, the switch receives instructions from a device 116 having access to both a source digital wallet 110 and a target digital wallet 110a, the instructions including instructions to transfer money from the source digital wallet 110 to the target digital wallet 110a. At step 420, the switch 210 sends a message to the source digital wallet 110 to cause the source digital wallet 110 to access a receiving interface 232 of the switch 210 to effect transmission of the money from the source digital wallet 110 to an intermediary account 212. In this way, the switch 210 receives the money from the source digital wallet 110 into an intermediary account 212.

The switch 210 then sends a message to the target digital wallet 110a (at step 430) to cause the target digital wallet 110a to access a transmitting interface 242 (such as an API) of the switch 210 to effect transmission of the money from the intermediary account 212 to the target digital wallet 110a, thereby completing the funds transfer.

Many modifications will be apparent to those skilled in the art without departing from the scope of the present invention.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

We claim:

1. A money transfer orchestration switch including:
an instruction receiving component for receiving transfer instructions to transfer money from a source digital wallet to a target digital wallet;
a money receiving component for receiving money from the source digital wallet into an intermediary account; and
a money transmitting component for transmitting the money from the intermediary account to the target digital wallet.

2. A money transfer orchestration switch as claimed in claim 1 configured to receive the transfer instructions from an instruction transmitting component operable on a computing device, the source digital wallet and target digital wallet being accessible from the computing device.

3. A money transfer orchestration switch as claimed in claim 1, wherein the money receiving component includes a source digital wallet communications component for communicating with the source digital wallet.

4. A money transfer orchestration switch as claimed in claim 4, wherein the source digital wallet communications component is configured to send a message to the source digital wallet to cause the source digital wallet to use a receiving interface of the money receiving component to effect transmission of the money from the source digital wallet to the intermediary account.

5. A money transfer orchestration switch as claimed in claim 1, wherein the money transmitting component includes a target digital wallet communications component for communicating with the target digital wallet.

6. A money transfer orchestration switch as claimed in claim 6, wherein the target digital wallet communications component is configured to send a message to the target digital wallet to cause the target digital wallet to use a transmitting interface of the money transmitting component to effect transmission of the money from the intermediary account to the target digital wallet.

7. A money transfer orchestration switch as claimed in claim 1, further including credential storage manager for storing and retrieving credentials for the source digital wallet and the target digital wallet.

8. A money transfer orchestration switch as claimed in claim 7, wherein the credentials include an identifier for the source digital wallet and the target digital wallet respectively.

9. A money transfer orchestration switch as claimed in claim 8, wherein the identifier is used to determine which is the source digital wallet and which is the target digital wallet.

10. A money transfer orchestration switch as claimed in claim 1, wherein the source digital wallet and the target digital wallet are associated with a single user.

11. A money transfer orchestration switch as claimed in claim 1, wherein the source digital wallet and the target digital wallet are provided by a single digital wallet provider.

12. A method for transferring money from a source digital wallet to a target digital wallet including, at a switch,
a. receiving the money from the source digital wallet into an intermediary account; and
b. transmitting the money from the intermediary account to the target digital wallet.

13. A method as claimed in claim 12, further including receiving instructions to transfer the money from the source digital wallet to the target digital wallet, the instructions being received from a device having access to both the source digital wallet and the target digital wallet.

14. A method as claimed in claim 12, further including sending a message to the source digital wallet to cause the source digital wallet to access a receiving interface of the switch to effect transmission of the money from the source digital wallet to the intermediary account.

15. A method as claimed in claim 12, further including sending a message to the target digital wallet to cause the target digital wallet to access a transmitting interface of the switch to effect transmission of the money from the intermediary account to the target digital wallet.

16. A method as claimed in claim 12, wherein the source digital wallet and the target digital wallet each has an identifier.

17. A method as claimed in claim 16, wherein the identifier is used to determine which is the source digital wallet and which is the target digital wallet.

18. A method as claimed in claim 12, wherein the source digital wallet and the target digital wallet are associated with a single user.

19. A method as claimed in claim 12, wherein the source digital wallet and the target digital wallet are provided by a single digital wallet provider.
